(19) United States
(12) Patent Application Publication
(10) Pub. No.: US 2008/0283646 A1
(43) Pub. Date: Nov. 20, 2008

(54) Size Reduction Apparatus

(76) Inventors: Shane Peter Omundsen, Cambridge (NZ); Gary Johnstone Martin, Dalyellup (AU); Alan Mark Garvin, New Farm (AU); Andrew William Kevin Lusty, Matamata (NZ)

Correspondence Address: JACOBSON HOLMAN PLLC, 400 SEVENTH STREET N.W., SUITE 600, WASHINGTON, DC, 20004, US

(21) Appl. No.: 11/661,400

(22) PCT Filed: Aug. 30, 2005
(86) PCT No.: PCT/NZ05/00228

§ 371 Date: Jan. 22, 2008

(30) Foreign Application Priority Data
Aug. 31, 2004 (NZ) 535037

(51) Int. Cl. B02C 7/11; B02C 7/08; B02C 17/16

(52) U.S. Cl. 241/250; 241/171; 241/257.1; 241/261.2

(57) ABSTRACT

A vertical crusher having a housing defined chamber, enclosing a vertical axis rotor. The chamber has material(s) feed inlet(s) into the chamber. There is a drop-through outlet, which may be closable, from the chamber from which material(s) of at least a maximum size can drop in use.

There are air inlet(s) into said chamber and air classifier outlet(s) from the chamber, for air or fine particles. Within the chamber also is a mass of discrete media, agitatable under the direct and/or indirect action of the rotor. The discrete media (erodable or unerodable) may be impact items such as metal balls

### FIELD OF INVENTION

The present invention relates to high energy vertical crushers.

A variety of different vertical shaft machines exist for the purpose of reducing the size of infeed materials. By way of example, we refer to the BARMAC™ range of autogenous mineral breakers or crushers which rely on a gravity assisted infeed to a rotor which accelerates over a retained bed of particles the materials to be broken into a surrounding mineral protected interaction zone from whence the materials of reduced size drop out.

### BACKGROUND OF THE INVENTION

The present invention wishes to provide an alternative to such apparatus which may find application for the reduction of size of materials. The present invention relates to such vertical shaft impacting crushers and/or offers at least an alternative to apparatus useful for size reduction and grinding.

It is therefore an object of the present invention to at least provide size reduction apparatus which will provide the public with a useful choice.

### BRIEF DESCRIPTION OF THE INVENTION

In a first aspect the present invention maybe said to broadly consist in a vertical crusher of a kind adapted to receive a feed of material(s) to be reduced in size (“feed material(s)”) and adapted to allow an outtake of such material(s) when reduced to a desired size range or desired size ranges, the crusher being characterised in that there is adaption for a media to act upon the material(s) to be agitated by at least a substantially vertical axis rotor,

and (preferably) being further characterised in that the media is in use caused to well up into a collection zone above the rotor from whence the media can drop for energisation by the rotor.

As used herein “media” includes impact material or materials, preferably in the form of discrete impact items such as balls, beads, granules, barrels, rods, etc or mixtures thereof, and irrespective of whether of the same size or size range, or not, and irrespective of whether of the same chemical and/or physical form.

As used herein the term “and/or” means “and” or “or”.

As used herein the term “(s)” following a noun means the plural or singular forms of the noun as may be appropriate.

Reference herein to “impact items” preferably refers to items the reduction in size of which is minimal (if any at all) and/or is very much slower than that to be expected for the materials to be reduced in size in the apparatus. For example the impact items are of a more water resistant nature than the feed materials to be reduced in size. Whilst reference herein is to “balls” (such as steel balls) any appropriately shaped items or mixture of items can be used. Moreover the materials of such items can be of any suitable impact material or materials (e.g. whilst ceramic or plastics materials may be appropriate in some applications, most preferably the impact items are of a metal or metal alloy).

In another aspect the invention is a vertical crusher having an agitation substantially vertical axis rotor for crushing media in a media retaining chamber,

wherein material(s) to be crushed under (inter alia) the action of the agitated media in use is removable from the chamber by an air classifier, or is optionally removable from the chamber by an air classifier,

In another aspect the invention is a vertical crusher having an agitation substantially vertical axis rotor for crushing media in a media retaining chamber,

wherein material(s) to be crushed under (inter alia) the action of the agitated media in use is removable from the chamber by an air classifier, or is optionally removable from the chamber by an air classifier,

and wherein a collector in the chamber collects media after an upward movement thereof under the direct and/or indirect action of the rotor and subsequently allows the media to drop on and/or towards the rotor on and/or about its axis.

In another aspect the invention is a vertical crusher having an agitation substantially vertical axis rotor for crushing media in a media retaining chamber,

wherein material(s) to be crushed under (inter alia) the action of the agitated media in use is removable from the chamber via at least one drop through and/or blow through outlet(s).

In another aspect the invention is a vertical crusher having an agitation substantially vertical axis rotor for crushing media in a media retaining chamber,

wherein material(s) to be crushed under (inter alia) the action of the agitated media in use is removable from the chamber via at least one drop through and/or at least one blow through outlet(s),

and wherein a collector in the chamber collects media after an upward movement thereof under the direct and/or indirect action of the rotor and subsequently allows the media to drop on and/or towards the rotor on and/or about its axis.

Preferably any drop through is into a pressurised air or gas environment.

In another aspect the present invention consists in a vertical crusher being or having

an at least substantially closed housing defining a chamber,

a rotor within the chamber rotatable about a substantially vertical axis,

at least one inlet (material(s) feed inlet(s)”) for the feed of material or materials (“feed material(s)”) into the chamber,

at least one outlet (“drop through outlet(s)”) [optionally substantially closable] from the chamber from whence material(s) of at least a maximum size can drop in use,

at least one inlet for air [or other gas] (“air inlet(s)”) into the chamber (whether via said inlet or said outlet(s) [substantially closed or otherwise]) or otherwise,

at least one air [or other gas] and/or fine particle outlet (“air classifier outlet(s)”) from the chamber, and

a mass of media (erodable or unerodable) [e.g. impact items (such as metal balls)] in the chamber and agitatable under the direct and/or indirect action of the rotor.

Preferably said chamber there is an air classifier.

Preferably said air classifier, at least in part, determines what feed materials once at least partially crushed pass out said air classifier outlet, and/or said drop through outlets, or remain within said vertical crusher.

Preferably said outtake of materials is at least in part aided by said air classifier.

Preferably said air classifier has air introduced from below said rotor.

Preferably at least part of said outtake is from above said rotor.

Preferably there is adaptation to allow part of said outtake to occur below said rotor.

Preferably said outtake above said rotor is of material finer than that which is outtaken from below said rotor.

Preferably said outtake below said rotor is controlled by an annular screen which only allows materials of a certain size to pass through.

Preferably said air classifier also dries said feed and or outtake materials.

Preferably said drying is achieved by the temperature of the air in said air classifier.

Preferably any drop through, via said drop through outlets, is into a pressurised air or gas environment.

Preferably said chamber is variable in volume.

Preferably said variation in volume is achieved by variation in the height of said chamber.

The invention is also a crusher as aforesaid operable in one mode where whilst air is drawn in via said at least air inlet(s), there is no open or substantially open (e.g. optionally air sealed) drop through outlet(s) from the chamber from whence material(s) can drop and the material(s) outtake (or at least the majority thereof) from said chamber is via the air classifier outlet(s).

Preferably the material(s) feed inlet(s) is a single inlet.

Preferably said material(s) feed inlet is from above the rotor but adjacent or about the rotational axis thereof.

Preferably there is in addition a separate inlet for the impact items. Preferably said separate intake for the impact items is from above the rotor but not necessarily to the rotational.

Preferably in said one mode the drop through outlet is masked whilst in a second mode where there is said air inlet(s) the masking is missing and/or a grading, screen or the like is instead provided.

Preferably said chamber has defining at least the drop through outlet(s) an annulus protected by a screen.

Preferably said chamber has defining at least the drop through outlet(s) an annulus protected by a screen.

Preferably in said first mode the masking is a drop in annulus that leaves some provision for air inlet but is capable of being sealed by the inflow of air against the discharge or substantial discharge of material(s).

Preferably the rotor is an annulus carrying straight, curved or other form vanes.

Or the rotor could be an autogenous BARMAC™ type rotor.

Preferably the arrangement of the vanes is substantially as herein described with or without reference to any one of the accompanying drawings.

Preferably the vanes support there above an annulus or an annulus is supported above the vanes.

Preferably said annulus above the vanes can in some forms be to some extent substantially frustoconical whilst in still other forms it can be a true planar annulus.

Preferably the arrangement of the air classifier outlet is such that it is an uplift from the chamber at some distance away from the rotational axis of the rotor. In some forms of the present invention a tubular shaft carrying or acting to define or be about the rotational axis of the rotor is an infeed for said materials.

Preferably the construction takes any of the forms hereinafter described.

In a further aspect the present invention consists in a vertical crusher adapted to receive a material(s) feed, said crusher being or having

an at least substantially closed housing defining a chamber,

a rotor within the chamber rotatable about a substantially vertical axis,

an inlet for impact items and/or impact items within the chamber,

a collection structure and duct or collection structure and opening for receiving agitated impact items above the rotor and to allow the drop through of such impact items back to the rotor at least about the rotational axis of the rotor,

at least one inlet (“material(s) feed inlet(s)”) for the feed of material or materials (“material(s)”) into the chamber,

at least one of
(i) a drop through outlet, and
(ii) an air inlet for air into the chamber (preferably both (i) and (ii) although one can serve in some guise as the other in some preferred forms), and

at least one air and/or fine particle outlet (“air classifier outlet(s)”) from the chamber,

a flow supply for pressurised air into the air inlet and/or an extractor for an outtake of air and particles via the air classifier outlet(s), and, optionally, a retained mass of impact items, and

wherein the apparatus is operable so that, under the effect of the rotor in use, there is a flow of agitated impact items up through and/or with material(s) being reduced in size and back onto the rotor via the collection structure and duct or collection structure and opening.

In a further aspect the present invention consists in a vertical crusher being or having,

an at least substantially closed housing defining a chamber,

a rotor within the chamber rotatable about a substantially vertical axis,

at least one inlet (material(s) feed inlet(s)”) for the feed of material or materials (“material(s)”) into the chamber,

an annular outlet (“drop through outlet(s)”) [optionally substantially closable] from the chamber from whence material(s) of at least a maximum size can drop in use,

at least one inlet for air [or other gas] (“air inlet(s)”) into the chamber (whether via said inlet or said outlet(s) [substantially closed or otherwise]) or otherwise,

at least one air [or other gas] and/or fine particle outlet (“air classifier outlet(s)”) from the chamber, and

a retained mass of media [e.g. impact items (such as metal balls)] in the chamber and agitatable under the direct and/or indirect action of the rotor.

wherein there is provision for a pressurisation with air of said air inlet(s) thereby to act as an air seal and to ensure a positive outflow of material(s) with the air flow(s) via said air classifier outlet(s).

Preferably where outtake is primarily by said air classifier outlet(s), preferably said drop through outlet is substantially closed and/or the drop through outlet(s) (optionally partially closed) is/are the air inlet(s).

In still a further aspect the invention consists in a vertical crusher being or having,

an at least substantially closed housing defining a chamber,

a rotor within the chamber rotatable about a substantially vertical axis,

at least one inlet (material(s) feed inlet(s)”) for the feed of material or materials (“material(s)”) into the chamber,

an annular drop through and/or air inflow outlet (“drop through outlet”) from the chamber about the rotor axis,

an air classifier outlet from the chamber

wherein the chamber includes a mass of media [e.g. impact items] and/or there is an intake into the chamber for such media, and/or

wherein there is apparatus to provide an air upflow through the drop through outlet and from thence out of the air classifier outlet, and/or

wherein a screen allows the drop through outlet to retain at least most of the media and/or an annular member can configure the drop through outlet to an air sealed support of the material(s) in use in the chamber (ie to prevent any substantial drop through).

In still a further aspect the invention consists in a vertical crusher being or having,

an at least substantially closed housing defining a chamber,

a rotor within the chamber rotatable about a substantially vertical axis,

at least one inlet (material(s) feed inlet(s)”) for the feed of material or materials (“material(s)”) into the chamber,

at least one inlet for air [or other gas] (“air inlet(s)”) into the chamber (whether via said inlet or said outlet(s) [substantially closed or otherwise]) or otherwise,

at least one air [or other gas] and/or fine particle outlet (“air classifier outlet(s)”) from the chamber, and

a retained mass of media [e.g. impact items (such as metal balls)] in the chamber and agitatable under the direct and/or indirect action of the rotor,

wherein there is provision for a pressurisation with air of and/or via said air inlet(s) thereby to act as an air seal and to ensure a positive outflow of material(s) with the air flow(s) via said air classifier outlet(s),

Preferably the chamber is configurable to reveal a drop through screen for material(s).

Preferably the impact items are of such a size and amount as to allow for a flow arrangement substantially as herein after described.

In yet a further aspect the present invention consists in the use of vertical crusher apparatus in accordance with the present invention in conjunction with media (preferably in the form of impact items such as balls).

Preferably said use involves the outtake of entrained particles from the air classifier outlet and optionally the outtake of drop through material(s) from the drop through outlet.

In yet a further aspect the present invention consists in the use of vertical crusher apparatus in accordance with the present invention for crushing in one or more of the modes:

(a) with the feed material(s) and without the media,

(b) with the feed material(s) and with the media and air classification outtake only,

(c) with the feed material(s) and with the media and the drop through outtake and the air classifier outtake, and/or

(d) with the feed material(s) and with the media and the drop through outtake only.

Preferably said use (b) and/or (c) and/or (d) involves the feed in of material(s) via the material(s) intake(s) [and, optionally, the addition of make up media after at least some material(s) infeed]. In preferred forms of the present invention the media is already within the chamber.

In still a further aspect the present invention consists in materials crushed by a vertical crusher or apparatus in accordance with the present invention.

In yet a further aspect the present invention consists in componentry forming part or to form part of crushing apparatus in accordance with the present invention or componentry in combination erectable to provide crushing apparatus in accordance with the present invention.

### BRIEF DESCRIPTION OF THE DRAWINGS

Preferred forms of the present invention will now be described with reference to the accompanying drawings in which,

FIG. 1 is a partly sectioned side elevation of a standard BARMAC B3000 Duopactor™ capable of being adapted to provide a vertical mill in accordance with the present invention,

FIG. 2 shows the apparatus of FIG. 1 to the extent to which it might change to provide a high energy vertical mill of a kind contemplated in the present invention,

FIG. 3 shows within a chamber (the lateral bounds not being shown in FIG. 3 for ease of viewing) a rotor rotatable about a vertical axis and having thereover a collector in the form of a funnel like hopper or ducted frustoconical member preferably having passing therethrough a duct by whence material(s) to be crushed (and also in some case air) can be fed axially of the rotor, FIG. 3 showing as a static bed the retained media which as depicted is preferably in the form of balls, beads or the like, FIG. 3 also showing an air classifier outlet from the chamber,

FIG. 4 is the same as FIG. 3 but showing the effect on the retained media as a consequence of rotor rotation, the means of rotation not being shown but being any of the kinds of drive customarily used in such crushers (e.g as with the BARMAC™ range), there being provision for an air intake optionally from below (none being shown but dark arrows showing from whence there could be such an air uptake) whilst air drawn in with material feed provides provision for an air classifier outtake of finds of the materials,

FIG. 5 shows in exploded view a standard B3000 Duopactor™ rotor,

FIGS. 6A through 6G show different variations of a rotor with vanes of various forms that preferably are used as rotors in a high energy vertical crusher in accordance with the present invention, that embodiment of FIG. 6G carrying its own frustoconical collector,

FIG. 7 shows particle separation in an extended chamber of height X of the vertical crusher where there is an air classifier outtake,

FIG. 8 shows the chamber configured without air classification,

FIG. 8A shows a mesh screen that allows material to pass after being crushed but retains the media,

FIG. 9 is a similar view to that of FIG. 8 but showing the use of a screen such as in FIG. 8A (or shown in FIG. 9A) which allows air classification outtake while still allowing oversize product to drop through the screen of FIG. 9A.

### DETAILED DESCRIPTION OF THE INVENTION

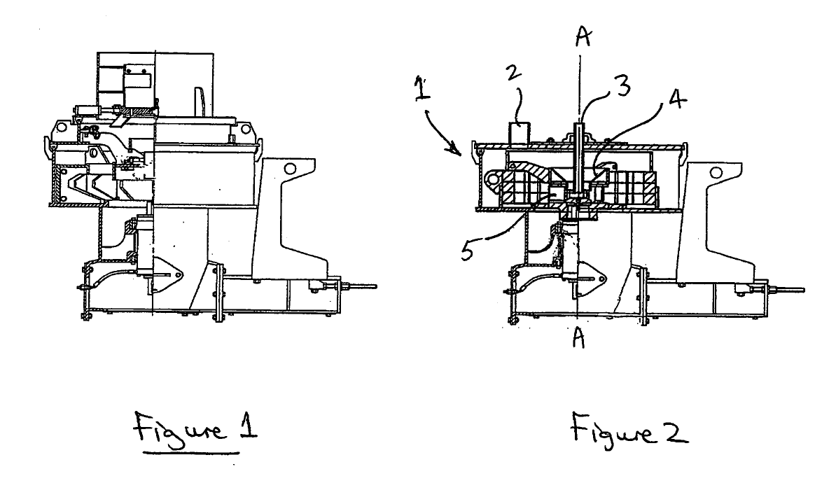

One preferred embodiment will now be described by reference to an adaption of a BARMAC B3000 Duopactor™ vertical crusher as depicted partially in section but in side elevation in FIG. 2.

As can be seen in FIG. 2 a chamber 1 is defined in the region hitherto that had the autogenous crushing chamber in the prior art BARMAC B3000 Duopactor™ crusher. Here, as shown in FIG. 2, the crusher with its air classification outlet 2 is shown having an infeed tube 3 axially of the vertical rotor 5 and passing centrally of a collection hopper 4 down to just above the rotational axis of the rotor 5.

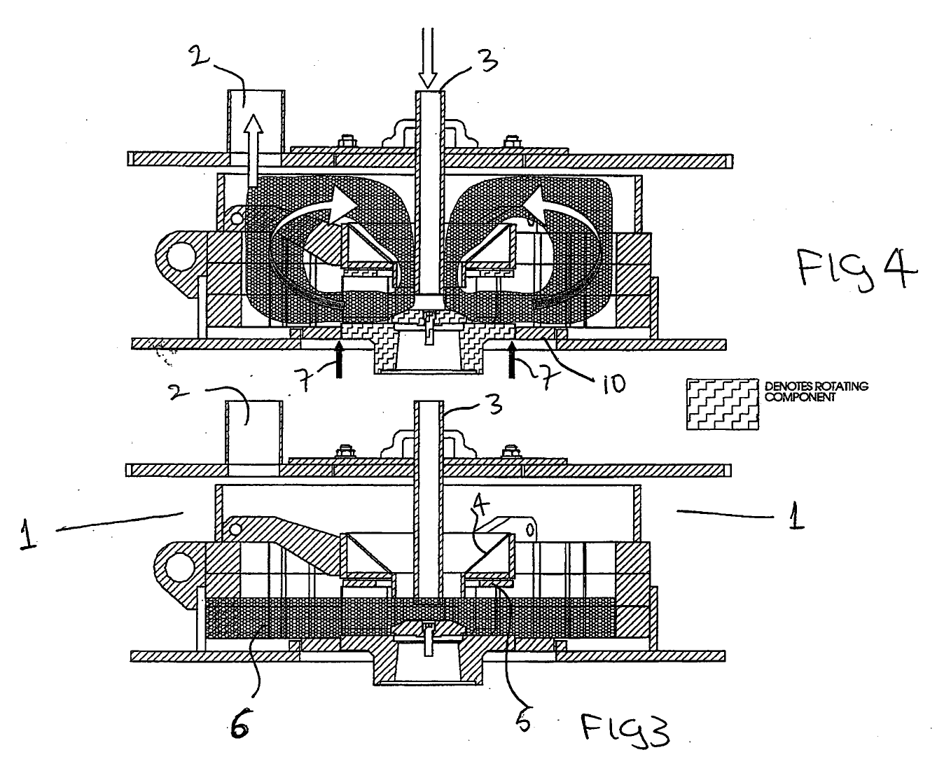

In the arrangement as shown in FIG. 3 it can be seen that the retained media 6 upon energisation by rotation of the rotor 5 has the ability to well up as in FIG. 4 under the direct and indirect action of the rotor 5 rotating about its vertical axis under any appropriate drive arrangement. There follows a collection of such uplifted media and the subsequent dropping thereof about the feed tube 3 back on to the rotor 5 where it mingles with the incoming material(s) and/or air which is dropped immediately above or within the rotor 5.

As shown by the arrows in FIG. 4, there is the prospect of an outtake via the air classifier 2 of fine material particles under the action of air incoming at least with the infeed materials entering via the in feed tube 3 but optionally also via air intakes at 7 which act as an air seal of any plugging annulus of the base that might optionally be provided to allow the plant to be reconfigured to the other guises hereinafter described.

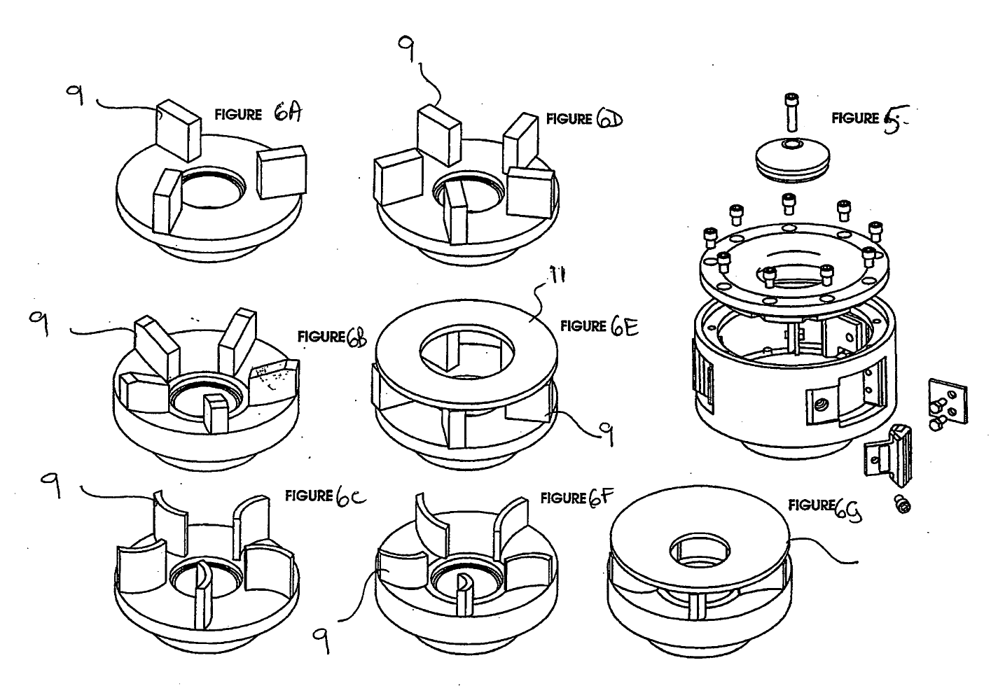

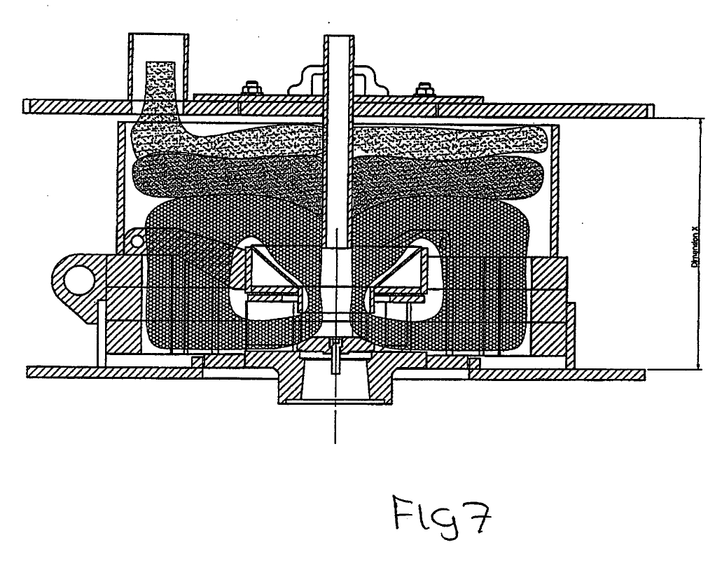

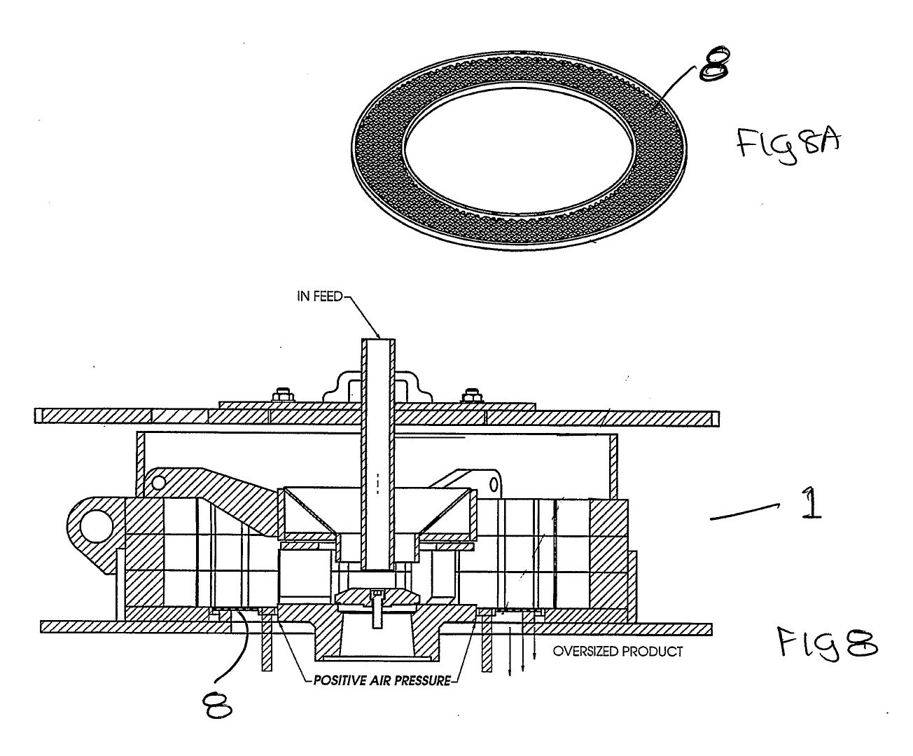

FIGS. 6A through 6G show a variety of different rotor forms, some with an annulus 11 on top. Each preferably is of a form with vanes 9 adapted to accelerate outwardly media 6 received downwardly on or adjacent the rotor 5 axis. FIG. 6E for example shows a form of rotor such as depicted as 5 in FIG. 3. FIG. 6G carries, instead of the annulus 11, a frustoconical member capable of acting as a collector 4. In the preferred form of the present invention however the collector 4 is in the form of a funnel like hopper that does not rotate with the rotor 5. That funnel like collector 4 preferably has a frustoconical or other similar collection part leading down to a duct that best ducts the media 6 to a zone where it mingles with incoming material.

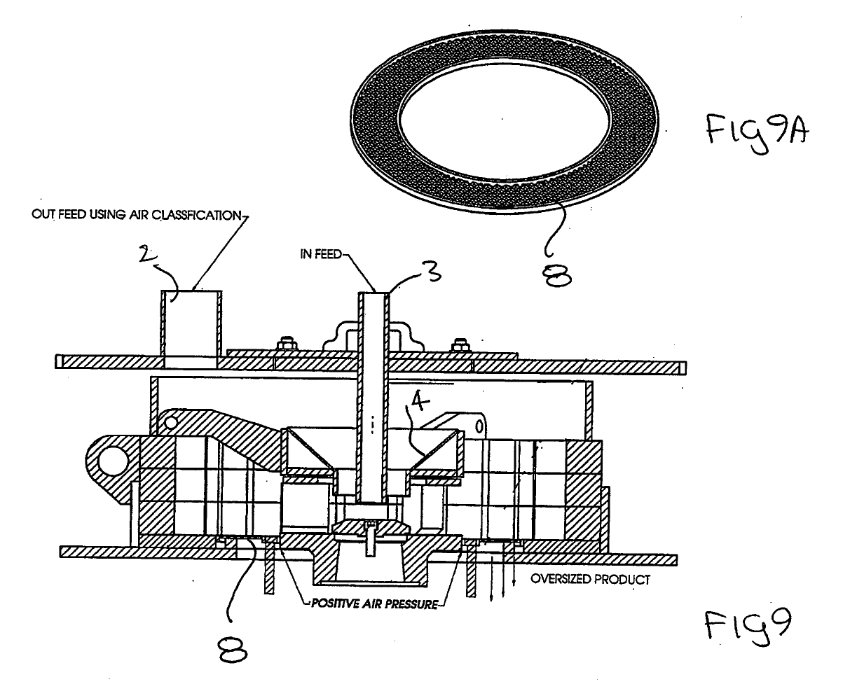

FIG. 7 shows a variation of the apparatus of FIGS. 3 and 4 where there is a greater height X thereby allowing some measure of stratification notwithstanding outtakes still being via air classifier only. The height X of the chamber 1 therefore can be varied to introduce the desired stratification. Persons skilled in the art will appreciate however, particularly by reference to variations as hereinafter described, how other outtakes are possible from the chamber.

FIG. 8 using an annular screen 8 as in FIG. 8A screen, but with no air classification outlet 2 (e.g. it could be temporarily blocked or may not even be provided), preferably operates in a similar manner to that of FIG. 4 but without any outtake by air classification. Instead product drops through the screen 8 as provided for optionally against a positive air pressure maintained in any underlying chamber or hopper below the chamber 1.

FIG. 9 shows a variation of the arrangement of FIG. 8 where there is an air classification outlet 2 in addition to the drop through capability provided by the screen 8. The in feed materials as they are subjected to the crushing action become smaller and smaller. The air classifier supplies or is supplied sufficient gas pressure (for example air under pressure introduced into the bottom of the chamber/crusher) to up lift particles of a required size. The air classifier gas pressure may also be at least in part created by the rotation of the rotor. The upward pressure of the classifier moves crushed infeed particles of a desired size (the classifier pressure being tuned to lift the required size as it develops in the crusher). The particles of the desired size thus are uplifted to the top of the chamber and are then removed. Thus as particles are continuously developed as the crusher operates, of the required size they are caught by the air classifier and moved to a position where they can be removed.

Additionally with the lower annular screen 8, particles of a larger size that are not entrained by the air classifier, yet are agitated sufficiently settle on the annular screen 8 and those of the correct size can then fall through. Additional air introduction if a pressure not sufficient to loft these particles may by the annular screen 8 so that they do not build up and block the screen, but rather are allowed to fall through. Thus from the one crusher two and even possibly more streams of graded crushed material can be extracted.

In a preferred embodiment the air introduced, either as part of the classifier or separately can be warmed. When the infeed material are either wet, or have absorbed moisture they can be artificially heavy and thus the air classifier may not work as desired. The introduction of warm air into the chamber will drive off the moisture thus producing a dry end product. This has the added benefit that the crushed materials will not clog or bind together due to moisture that may otherwise be present.

It is envisaged in operation the configuration and componentry of apparatus in accordance with the present invention will be tuned to the outcomes required taking account of the energy inputs, the throughputs required, the nature of the material or materials being infed, the air flows, and the outcome products wanted.

The media 6 can be of any suitable materials but in preferred forms, where a chemical interaction is not of concern, preferably involves discrete impact items of a suitable metal such as steel. Ideally therefore impact items in the form of balls are provided preferably all of the same size even though at any particular time within the system the balls may vary in size owing to wear.

It is within the scope of the present invention from time to time to drop in make up quantities of any impact items or media (e.g. optionally with or serially with any intake of materials preferably via the central axis tube 3).

Another feature of the present invention is the provision of a potential collection chamber below the chamber 1 and one which can be maintained at an over pressure in comparison to the air pressure within the chamber 1 such that air classification outlet 2 is a possibility without detracting from materials and air intake via the in feed tube 3. As shown by way of example in FIG. 4 an annular plate 10 whether fully or partly occluding any drop throughout can be used rather than an annular screen 8.

Also it is to be seen that the nature of the rotor 5 and its vanes 9 can vary and it is not even necessary that the rotor take any of the forms depicted in FIG. 6A through 6G as other forms will have the ability to agitate and perturb the media 6 and to have the media 6 act upon the material(s) being fed through the chamber 1.

A feature of preference is the internal recirculation of the media 6 with the ability of, for example, balls to jump back into a feed hopper above the spinning rotor 5.

Another feature optionally considered of importance is the ability to pass air between the bottom of the chamber 1 and the spinning rotor 5 thereby to act optionally as an air seal and/or as at least a partial source of air for air classification purposes.

Another feature of the present invention, provided there is an air inlet if air classification is required, is the prospect of a provision of a labyrinth type seal at the base of the container.

Another aspect of the present invention is the prospect that any enhanced air flow could be utilised as an additional agitating agent in the chamber 1.

Another aspect of the present invention is the prospect of multiple air inflows with at least a primary or secondary air flow optionally being via the solids infeed.

In alternative versions the present invention could envisage no air circulation but still the provision of an air inlet and some air assist blow through of materials of appropriate size through the annular screen.

It is envisaged however that careful tuning of the system is necessary to provide an appropriate mass balance of feed against outtake, material and media 6 content within the chamber 1, etc. The prospect remains that if media 6 is provided in too great a quantity there is the prospect of dead spaces even if the chamber 1 and rotor are appropriately configured to avoid such spaces. The charge of materials and the charge of media 6 needs to relate to the operation required so as to obtain the right outcomes for the input parameters and structural parameters.

It is envisaged, for example, in a form where there is a air classifier outlet 2 as well a solids drop through outtake, that the greater mass of materials is taken out via the drop through outtake as opposed to the air classifier outlet 2. In other systems however all of the materials could be taken out by air classification.

It is envisaged in preferred forms of the present invention that the natural repose of the media 6 will be such that initiation of rotation of the rotor 5 (e.g under the action of an electric motor) irrespective of whether or not any material(s) is already present in the chamber, as energy is generated in the bed of media 6, will ultimately lead to the balls becoming agitated and then welling up and assuming the circulatory flow preferably desired.

It is believed that vertical crushers in accordance with the present invention should provide a viable alternative to those customarily used for the breaking down of minerals, rocks etc and indeed any other materials that are to be broken down in size and/or eroded in some way.

The foregoing description of the invention includes preferred forms thereof. Modifications may be made thereto without departing from the scope of the invention as defined by the accompanying claims.

1. A vertical crusher being or having
an at least substantially closed housing defining a chamber,
a rotor within the chamber rotatable about a substantially vertical axis,
at least one inlet (material(s) feed inlet(s)”) for the feed of material or materials (“feed material(s)”) into the chamber,
at least one outlet (“drop through outlet(s)”) [optionally substantially closable] from the chamber from whence material(s) of at least a maximum size can drop in use,
at least one inlet for air [or other gas] (“air inlet(s)”) into said chamber (whether via said inlet or said outlet(s) [substantially closed or otherwise]) or otherwise,
at least one air [or other gas] and/or fine particle outlet (“air classifier outlet(s)”) from the chamber, and
a mass of media (erodable or unerodable) [e.g. impact items (such as metal balls)] in the chamber and agitatable under the direct and/or indirect action of the rotor.

2. The vertical crusher as claimed in claim 1 wherein within said chamber there is an air classifier.

3. The vertical crusher as claimed in claim 2 wherein said air classifier, at least in part, determines what feed materials once at least partially crushed pass out said air classifier outlet, and/or said drop through outlets, or remain within said vertical crusher.

4. The vertical crusher as claimed in claim 2 wherein said outtake of materials is at least in part aided by said air classifier.

5. The vertical crusher as claimed in any claim 2 wherein said air classifier has air introduced from below said rotor.

6. The vertical crusher as claimed in claim 1 wherein at least part of said outtake is from above said rotor.

7. The vertical crusher as claimed in claim 1 wherein there is adaptation to allow part of said outtake to occur below said rotor.

8. The vertical crusher as claimed in claim 6 wherein said outtake above said rotor is of material finer than that which is outtaken from below said rotor.

9. The vertical crusher as claimed in claim 7 wherein said outtake below said rotor is controlled by an annular screen which only allows materials of a certain size to pass through.

10. The vertical crusher as claimed in claim 2 wherein said air classifier also dries said feed and or outtake materials.

11. The vertical crusher as claimed in claim 10 wherein said drying is achieved by the temperature of the air in said air classifier.

12. The vertical crusher as claimed in claim 1 wherein any drop through, via said drop through outlets, is into a pressurised air or gas environment.

13. The vertical crusher as claimed in claim 1 wherein said chamber is variable in volume.

14. The vertical crusher as claimed in claim 13 wherein said variation in volume is achieved by variation in the height of said chamber.

15. A vertical crusher adapted to receive a material(s) feed, said crusher being or having
an at least substantially closed housing defining a chamber,
a rotor within the chamber rotatable about a substantially vertical axis,
an inlet for impact items and/or impact items within the chamber,
a collection structure and duct or collection structure and opening for receiving agitated impact items above the rotor and to allow the drop through of such impact items back to the rotor at least about the rotational axis of the rotor,
at least one inlet (“material(s) feed inlet(s)”) for the feed of material or materials (“material(s)”) into the chamber,
at least one of (i) a drop through outlet and (ii) an air inlet for air into the chamber (preferably both (i) and (ii) although one can serve in some guise as the other in some preferred forms), and
at least one air and/or fine particle outlet (“air classifier outlet(s)”) from the chamber,
a flow supply for pressurised air into the air inlet and/or an extractor for an outtake of air and particles via the air classifier outlet(s), and, optionally, a retained mass of impact items, and
wherein the apparatus is operable so that, under the effect of the rotor in use, there is a flow of agitated impact items up through and/or with material(s) being reduced in size and back onto the rotor via the collection structure and duct or collection structure and opening.

16. A vertical crusher being or having,
an at least substantially closed housing defining a chamber,
a rotor within the chamber rotatable about a substantially vertical axis,
at least one inlet (material(s) feed inlet(s)”) for the feed of material or materials (“material(s)”) into the chamber,
an annular outlet (“drop through outlet(s)”) [optionally substantially closable] from the chamber from whence material(s) of at least a maximum size can drop in use,
at least one inlet for air [or other gas] (“air inlet(s)”) into the chamber (whether via said inlet or said outlet(s) [substantially closed or otherwise]) or otherwise,
at least one air [or other gas] and/or fine particle outlet (“air classifier outlet(s)”) from the chamber, and
a retained mass of media [e.g. impact items (such as metal balls)] in the chamber and agitatable under the direct and/or indirect action of the rotor.
wherein there is provision for a pressurisation with air of said air inlet(s) thereby to act as an air seal and to ensure a positive outflow of material(s) with the air flow(s) via said air classifier outlet(s).

17. The vertical crusher as claimed in claim 16 wherein where outtake is primarily by said air classifier outlet(s), preferably said drop through outlet is substantially closed and/or the drop through outlet(s) (optionally partially closed) is/are the air inlet(s).

18. A vertical crusher being or having,
an at least substantially closed housing defining a chamber,
a rotor within the chamber rotatable about a substantially vertical axis,
at least one inlet (material(s) feed inlet(s)”) for the feed of material or materials (“material(s)”) into the chamber,
an annular drop through and/or air inflow outlet (“drop through outlet”) from the chamber about the rotor axis,
an air classifier outlet from the chamber
wherein the chamber includes a mass of media [e.g impact items] and/or there is an intake into the chamber for such media, and/or
wherein there is apparatus to provide an air upflow through the drop through outlet and from thence out of the air classifier outlet, and/or
wherein a screen allows the drop through outlet to retain at least most of the media and/or an annular member can configure the drop through outlet to an air sealed support of the material(s) in use in the chamber (i.e. to prevent any substantial drop through).

19. A vertical crusher being or having,
an at least substantially closed housing defining a chamber,
a rotor within the chamber rotatable about a substantially vertical axis,
at least one inlet (material(s) feed inlet(s)”) for the feed of material or materials (“material(s)”) into the chamber,
at least one inlet for air [or other gas] (“air inlet(s)”) into the chamber (whether via said inlet or said outlet(s) [substantially closed or otherwise]) or otherwise,
at least one air [or other gas] and/or fine particle outlet (“air classifier outlet(s)”) from the chamber, and
a retained mass of media [e.g. impact items (such as metal balls)] in the chamber and agitatable under the direct and/or indirect action of the rotor,
wherein there is provision for a pressurisation with air of and/or via said air inlet(s) thereby to act as an air seal and to ensure a positive outflow of material(s) with the air flow(s) via said air classifier outlet(s).

20. The vertical crusher as claimed in claim 19 wherein the chamber is configurable to reveal a drop through screen for material(s).

21. The vertical crusher as claimed in claim 19 wherein the impact items are of such a size and amount as to allow for a flow arrangement substantially as herein after described.

22. A vertical crusher of a kind adapted to receive a feed of material(s) to be reduced in size (“feed material(s)”) and adapted to allow an outtake of such material(s) when reduced to a desired size range or desired size ranges, the crusher being characterised in that there is adaption for a media to act upon the material(s) to be agitated by at least a substantially vertical axis rotor,
and (preferably) being further characterised in that the media is in use caused to well up into a collection zone above the rotor from whence the media can drop for energisation by the rotor.

23. A vertical crusher having an agitation substantially vertical axis rotor for crushing media in a media retaining chamber,
wherein material(s) to be crushed under (inter alia) the action of the agitated media in use is removable from the chamber by an air classifier, or is optionally removable from the chamber by an air classifier.

24. A vertical crusher having an agitation substantially vertical axis rotor for crushing media in a media retaining chamber,
wherein material(s) to be crushed under (inter alia) the action of the agitated media in use is removable from the chamber by an air classifier, or is optionally removable from the chamber by an air classifier.
and wherein a collector in the chamber collects media after an upward movement thereof under the direct and/or indirect action of the rotor and subsequently allows the media to drop on and/or towards the rotor on and/or about its axis.

25. A vertical crusher having an agitation substantially vertical axis rotor for crushing media in a media retaining chamber,
wherein material(s) to be crushed under (inter alia) the action of the agitated media in use is removable from the chamber via at least one drop through and/or blow through outlet(s).

26. A vertical crusher having an agitation substantially vertical axis rotor for crushing media in a media retaining chamber,
wherein material(s) to be crushed under (inter alia) the action of the agitated media in use is removable from the chamber via at least one drop through and/or at least one blow through outlet(s),
and wherein a collector in the chamber collects media after an upward movement thereof under the direct and/or indirect action of the rotor and subsequently allows the media to drop on and/or towards the rotor on and/or about its axis.

27. The vertical crusher as claimed in claim 26 wherein any drop through is into a pressurised air or gas environment.

28. A use of vertical crusher apparatus in accordance with the present invention in conjunction with media (preferably in the form of impact items such as balls).

29. The use of vertical crusher apparatus as claimed in claim 28 wherein said use involves the outtake of entrained particles from the air classifier outlet and optionally the outtake of drop through material(s) from the drop through outlet.

30. A use of vertical crusher apparatus in accordance with the present invention for crushing in one or more of the modes.
(a) with the feed material(s) and without the media,
(b) with the feed material(s) and with the media and air classification outtake only,
(c) with the feed material(s) and with the media and the drop through outtake and the air classifier outtake, and/or
(d) with the feed material(s) and with the media and the drop through outtake only.

31. The use of vertical crusher apparatus as claimed in claim 30 wherein said use (b) and/or (c) and/or (d) involves the feed in of material(s) via the material(s) intake(s) [and, optionally, the addition of make up media after at least some material(s) infeed].

32. The use of vertical crusher apparatus as claimed in claim 30 wherein said media is already within the chamber.

33. A crusher as aforesaid operable in one mode where whilst air is drawn in via said at least air inlet(s), there is no open or substantially open (e.g. optionally air sealed) drop through outlet(s) from the chamber from whence material(s) can drop and the material(s) outtake (or at least the majority thereof) from said chamber is via the air classifier outlet(s).

34. The crusher as claimed in claim 33 wherein the material(s) feed inlet(s) is a single inlet.

35. The crusher as claimed in claim 33 wherein said material(s) feed inlet is from above the rotor but adjacent or about the rotational axis thereof.

36. The crusher as claimed in claim 33 wherein there is in addition a separate inlet for the impact items.

37. The crusher as claimed in claim 36 wherein said separate inlet for the impact items is from above the rotor but not necessarily to the rotational.

38. The crusher as claimed in claim 33 wherein in said one mode the drop through outlet is masked whilst in a second mode where there is said air inlet(s) the masking is missing and/or a grading, screen or the like is instead provided.

39. The crusher as claimed in claim 33 wherein said chamber has defining at least the drop through outlet(s) an annulus protected by a screen.

40. The crusher as claimed in claim 33 wherein in said first mode the masking is a drop in annulus that leaves some provision for air inlet but is capable of being sealed by the inflow of air against the discharge or substantial discharge of material(s).

41. The crusher as claimed in claim 33 wherein the rotor is an annulus carrying straight, curved or other form vanes.

42. The crusher as claimed in claim 33 wherein said rotor could be an autogenous BARMAC™ type rotor.

43. The crusher as claimed in either of claim 41 wherein the arrangement of said vanes is substantially as herein described with or without reference to any one of the accompanying drawings.

44. The crusher as claimed in claim 41 wherein said vanes support there above an annulus or an annulus is supported above said vanes.

45. The crusher as claimed in claim 44 wherein said annulus above said vanes can in some forms be to some extent substantially frustoconical whilst in still other forms it can be a true planar annulus.

46. The crusher as claimed in claim 33 wherein the arrangement of the air classifier outlet is such that it is an uplift from the chamber at some distance away from the rotational axis of the rotor.

47. The crusher as claimed in claim 33 wherein there is a tubular shaft carrying or acting to define or be about the rotational axis of the rotor is an infeed for said materials.

48. The crusher as claimed in claim 33 wherein the construction takes any of the forms hereinbefore described with reference to any one or more of the accompanying drawings.

49. (canceled)

50. (canceled)

51. (canceled)
